(19) United States
(12) Patent Application Publication
(10) Pub. No.: US 2005/0114208 A1
(43) Pub. Date: May 26, 2005

(54) System and method for guiding a computer user to promotional material

(76) Inventors: Robert P. Arbuckle, Orem, UT (US); Dirk J. Avery, Spring, TX (US)

Correspondence Address: GRANT R CLAYTON;CLAYTON HOWARTH & CANNON, PC, P O BOX 1909, SANDY, UT, 84091-1909, US

(21) Appl. No.: 10/925,351

(22) Filed: Aug. 23, 2004

Related U.S. Application Data
(63) Continuation of application No. 09/714,786, filed on Nov. 15, 2000, now abandoned.

(51) Int. Cl. G06F 17/60

(52) U.S. Cl. 705/14

(57) ABSTRACT

A method for guiding consumers to promotional material stored electronically on a computer database is described. The consumers are directed to a website where the promotional material can be accessed. A list of geographic locations where the promotional material is usable is provided for the consumer to select. The consumer selects a geographic location and then categories of promotional material are provided for the consumer to further define the area of interest for promotional material. The promotional material for the selected geographic location and category is then displayed for the consumer. The consumer can select and print the desired promotional material. Promotional material in the form of weekly advertisements are prepared in a media independent form prior to entry on the web site. The advertisements are stored in an encapsulated postscript file, manipulated to the desired form, and stored as a digital image in a compressed file with key words. The consumer can then search for particular items in the promotional material through the key words.

### CROSS-REFERENCE TO RELATED APPLICATIONS

This application is a continuation of co-pending U.S. patent application Ser. No. 09/714,786, filed Nov. 15, 2000, entitled SYSTEM AND METHOD OF GUIDING A COMPUTER USER TO PROMOTIONAL MATERIAL,” which is hereby incorporated by reference herein in its entirety, including but not limited to those portions that specifically appear hereinafter, the incorporation by reference being made with the following exception: In the event that any portion of the above-referenced application is inconsistent with this application, this application supercedes said portion of said above-referenced application.

### STATEMENT REGARDING FEDERALLY SPONSORED RESEARCH OR DEVELOPMENT

Not Applicable.

### BACKGROUND OF THE INVENTION

1. The Field of the Invention

The present invention relates generally to the distribution of promotional material, and more particularly, but not necessarily entirely, to a system and method for guiding computer users to promotional material over online networks.

2. Description of Related Art

It is common practice for businesses to market products and services by providing promotional material to potential customers. For example, businesses commonly advertise sales for goods and services in newspapers. Sunday editions of newspapers regularly contain a supplement of advertisements from various businesses. Also, paper coupons which provide a discount to the consumer as an inducement to purchase a particular good or service are commonly distributed in newspapers, magazines, and direct mailings. Paper coupons and advertisements are inefficient due to the cost of printing and distributing, and the fact that many of the coupons and advertisements printed and distributed are not actually used. The advertisements and coupons are distributed to everyone who subscribes to the newspaper, for example, and not just the individuals who are interested in purchasing the particular goods and services being promoted.

Attempts have been made to increase the efficiency of coupon distribution by utilizing computer systems. For example, U.S. Pat. No. 5,907,830 (granted May 25, 1999 to Engel et al.) discloses an electronic coupon distribution system. The system provides on-line coupon information for a potential consumer using a personal computer connected to a host computer. The potential consumer may specify product preferences or search and view coupons of interest to the consumer. The potential consumer may then download coupon information from the host computer to be printed. Despite this system providing some advantages over previously available systems, the system does not provide a simple method for guiding the potential consumer to the coupons which are available for being redeemed in a particular geographic area. Furthermore, the system does not provide for the distribution of weekly advertisements for a particular geographic area.

Similarly, U.S. Pat. No. 5,761,648 (granted Jun. 2, 1998 to Golden et al.) discloses a data processing system issuing electronic certificates, including coupons, through on-line networks of personal computers. The system displays active coupon files to potential consumers. The potential consumers are required to browse among the coupons to make a selection rather than being guided to the coupons which are available for being redeemed in a particular geographic area. Also, the system does not allow the potential consumer to search for advertised sales in a particular geographic area.

With the increasing importance of online commerce in many parts of the world, it is important to help consumers, even those who are hesitant to “go online,” to utilize online resources when purchasing products or even to merely obtain information about products to purchase from a traditional local retailer. The currently available systems and methods disadvantageously do not address helping a consumer to become more familiar with online resources so as to encourage, and even entice, a consumer (who may have never desired to shop online), to utilize online resources to determine what is available from one or more local retailers.

In view of the foregoing state of the art, it would be an advancement in the art to provide a system and method for guiding a computer user to promotional material which is simple to use and which the promotional material is grouped into easily distinguished categories. It would also be an additional advancement in the art to provide a system and method for guiding a computer user to the promotional material which is applicable to a selected geographic area. It would also be a further advancement in the prior art to provide a system and method for guiding a computer user to promotional material which provides for efficient distribution of promotional material, and in which the promotional material which corresponds to advertisements which appear in periodic publications.

### OBJECTS AND BRIEF SUMMARY OF THE INVENTION

In view of the drawbacks and disadvantages now present in the industry, it is an object of the present invention to provide a system and method for guiding a computer user to promotional material which is simple and inviting for the computer user to utilize.

It is another object of the present invention to provide a system and method for guiding a computer user to the particular promotional material which is applicable to a selected geographic area.

It is an additional object of the present invention to provide a system and method for guiding a computer user to the promotional material in which the promotional material corresponds to advertisements which appear in printed publications, including periodically available publications.

It is a further object of the present invention, in accordance with one aspect thereof, to provide a system and method for guiding a computer user to promotional material which provides for efficient distribution of promotional material.

It is an another object of the present invention to provide a system and method for guiding a computer user to promotional material in which the cost of providing the promotional material per customer decreases as the number of customers increases.

It is an additional object of the present invention, in accordance with one aspect thereof, to provide a system and method for guiding a computer user to promotional material which groups the promotional material into easily distinguished categories for selection by the computer user.

The above recited objects and others not specifically recited are realized in a specific illustrative embodiments of a system and method for guiding a computer user to promotional material. As described above, the previously available systems are characterized by several disadvantages and drawbacks that are addressed by the present invention. The present invention minimizes, and in some aspects eliminates, the above-mentioned failures, and other problems, by utilizing the methods and structural features described herein.

In accordance with the present invention, promotional material which is being planned to be distributed in a printed form can readily be prepared to be conveniently displayed to computer users, for example via a world wide web site conveyed to the computer user via the internet. In the case of promotional material which are generally distributed in the form of printed advertisements included with newspapers, such advertisements can be preferably be arranged in a form for display on a website for use by a computer user by: preparing the promotional material in a media independent form; storing the promotional material in an encapsulated post script file; manipulating the encapsulated post script file to a form for placement on a web page; creating a digital image of the manipulated encapsulated post script file and storing the digital image in a compressed file with key words including prices of the advertised items; entering the compressed file on the computer database; and providing the web page for the computer user to access the promotional material. It is preferred that the computer user search for key words to find the advertisements for particular items, or select from a list of businesses extending the advertisements to allow the user to browse available advertisements.

Additionally, one preferred method of the present invention includes, for example either alone or in combination with the above-described steps: guiding a computer user to a website containing the promotional material; providing a list of broad geographic locations where the promotional material is available; directing the computer user to select from the list of broad geographic locations; providing a list of specific geographic locations where the promotional material is available; directing the computer user to select from the list of specific geographic locations; providing a list of categories of the promotional material; directing the computer user to select from the list of categories; providing a list of subcategories of the promotional material; directing the computer user to select from the list of subcategories; and providing the computer user with the promotional material. The promotional material may be in the form of coupons which can be selected and printed to be redeemed at the applicable business.

Additional objects and advantages of the invention will be set forth in the description which follows, and in part will be apparent from the description, or may be learned by the practice of the invention without undue experimentation. The objects and advantages of the invention may be realized and obtained by way of the instruments and combinations particularly pointed out in the appended claims.

### BRIEF DESCRIPTION OF THE DRAWINGS

The above and other objects, features and advantages of the invention will become apparent from a consideration of the subsequent detailed description presented in connection with the accompanying drawings in which:

FIG. 1 is a diagram showing how a computer user is guided to a website containing the promotional material in accordance with one preferred aspect of the present invention.

FIG. 2 is a diagram showing the preferred steps utilized to guide a computer user to promotional material via a computer network.

FIGS. 3A-3C are a representations of a preferred graphical images presented to a computer user via a computer network with FIG. 3C providing a diagram of categories in which the promotional material can be grouped to easily distinguish the different categories of promotional material for the computer user.

FIG. 4 is a diagram the preferred relationship between the appearance of a printed publication and the appearance of a computer display configured in accordance with the present invention.

FIG. 4A is a diagram showing preferred steps utilized to arrive at the relationship between a printed publication and a computer display represented in FIG. 4.

FIG. 4B is a diagram showing preferred steps utilized to prepare weekly advertisements for presentation to a consumer via the internet in accordance with the present invention.

FIG. 5 is a diagram showing the different ways a computer user can access promotional material in the form of weekly advertisements utilizing the present invention.

FIG. 6 is a schematic diagram of a web page listing entities offering promotional material which can be selected to display weekly advertisements in keeping with one aspect of the present invention.

FIG. 7 is a schematic diagram of an exemplary layout of a web page corresponding to a printed publication including weekly advertisements.

### DETAILED DESCRIPTION OF THE PREFERRED EMBODIMENTS

For the purposes of promoting an understanding of the inventive principles of the invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would normally occur to one skilled in the relevant art and having possession of this disclosure, are to be considered within the scope of the invention claimed herein.

Definitions of key terminology used herein will now be provided.

“Promotional material” as used herein refers to any type of marketing material such as for example, coupons, discounts, advertisements, incentives, or any other such implement known to those skilled in the art of marketing, to promote goods or services.

“Computer user” or “consumer,” as referred to herein includes those who utilize electronic devices, including those currently known or known in the future, which are capable of conveying information over a distance and allowing access to promotional material.

“Computer network” as used herein includes a system of electronic devices, including those currently known or known in the future, capable of communicating information between spaced apart locations, including information representing promotional material.

“Computer” as used herein includes any device used to manipulate and display textual or graphical material to a computer user, including devices now know or which become available in the future, with the industry standard PC compatible computer being one preferred example of a computer within the meaning of that term as used herein.

“Weekly advertisements” as used to herein include advertisements which are capable of being distributed on a periodic basis such as in a Sunday supplement in a newspaper, for example. However, the term weekly advertisements is not limited to those advertisements distributed only on a periodic basis, but include any advertisement known to those skilled in the art whether distributed periodically or distributed randomly or distributed only once.

“Website” as used herein refers to data stored electronically which is accessible through a computer network. Other related terminology used herein is described more fully in the publications: Black, Uyless, Internet Architecture An Introduction to IP Protocols (Prentice Hall 2000) and Mudry, Robert Jon, Serving the Web (Coriolis Group 1995), which are now incorporated herein by reference in their entireties.

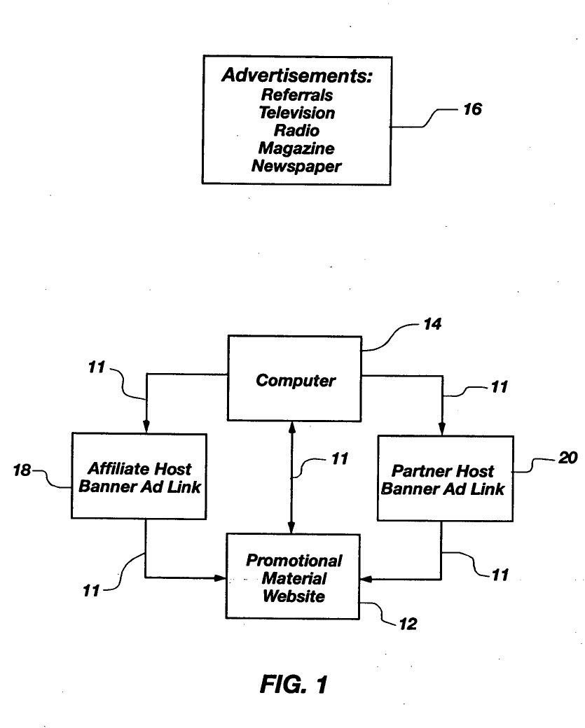

Referring now to FIG. 1, a block diagram shows one preferred arrangement, in accordance with the present invention, how a consumer or computer user is guided through a computer 14 to a website 12 containing promotional material. The present invention provides great improvements over the previously available systems by making it easier for the computer user to find the desired promotional material. The website 12 is preferably advertised through known media 16 such as television, radio, magazines, newspapers, other websites or referrals. Referrals can be promoted by, for example, offering incentives to consumers who refer other consumers to the website 12 and in other ways know to those skilled in the art.

Also, advertisements in the form of banner ads having links to the website can be placed on websites of affiliates 18. When a consumer is on the website of an affiliate 18, the banner ad is displayed. The consumer can automatically access the website 12 by activating link ad in a manner known in the art such as clicking on the banner ad with a mouse. Affiliates can be compensated based on the number of consumers registering with the promotional material website through the affiliate website. This will give others an incentive to promote the website 12. Affiliates with top-tier sites having consistently higher traffic and larger subscriber bases are referred to as partners 20. Partner sites function similar to other affiliate sites but can be offered additional incentives due to their higher traffic.

The computer 14 is connected to the hosts 18, 20 and the website 12 through communication links 11 which include any variety of communication link known presently or which become available in the future for communicating electronic data on a computer network.

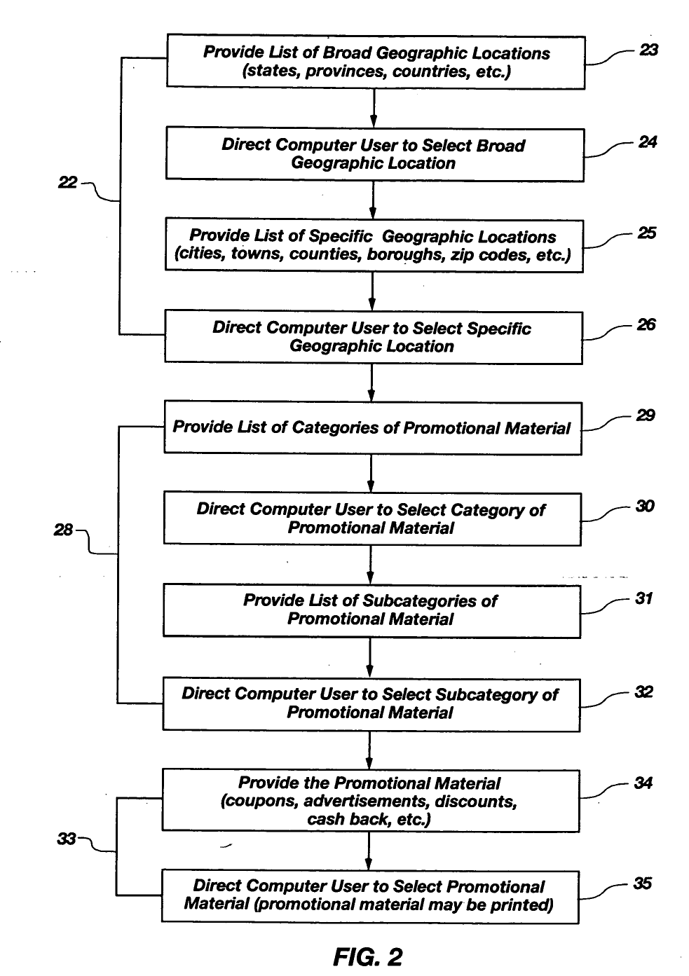

The following steps may be desirably carried out alone, or in combination with other steps described herein, as will be readily recognized by those skilled in the pertinent art. Once the consumer has accessed the website 12, the system preferably guides the consumer through three readily followed stages to access the relevant promotional material as shown in FIG. 2. Stage one, shown generally at 22, includes selecting the appropriate geographical location. First a list of broad geographic locations is provided 23, and the consumer is directed to select a broad geographical location 24 from the list. Broad geographic locations as referred to herein include categories such as states, countries, provinces, nations, or any other geographic location characterized by a similar large geographic area. It will be appreciated by those skilled in the art that other types of broad geographical locations can be used within the scope of the present invention.

After selecting a broad geographic location, a list of specific geographic locations 25 in the selected broad geographic location is displayed, and the consumer is prompted to select a specific geographic location 26 from the list. Specific geographic locations as referred to herein include, for example, cities, towns, counties, boroughs, zip code areas or any other geographic areas characterized by a similar size as the specific geographical locations listed. Specific geographical locations are of a size such that a consumer would typically travel distances within the specific geographical location to shop for goods and services. It will be appreciated by those skilled in the art that other types of specific geographical locations can be used within the scope of the present invention. Stage two, shown generally at 28, involves choosing a category of the desired promotional material. A list of categories 29 of the promotional material is displayed for the consumer.

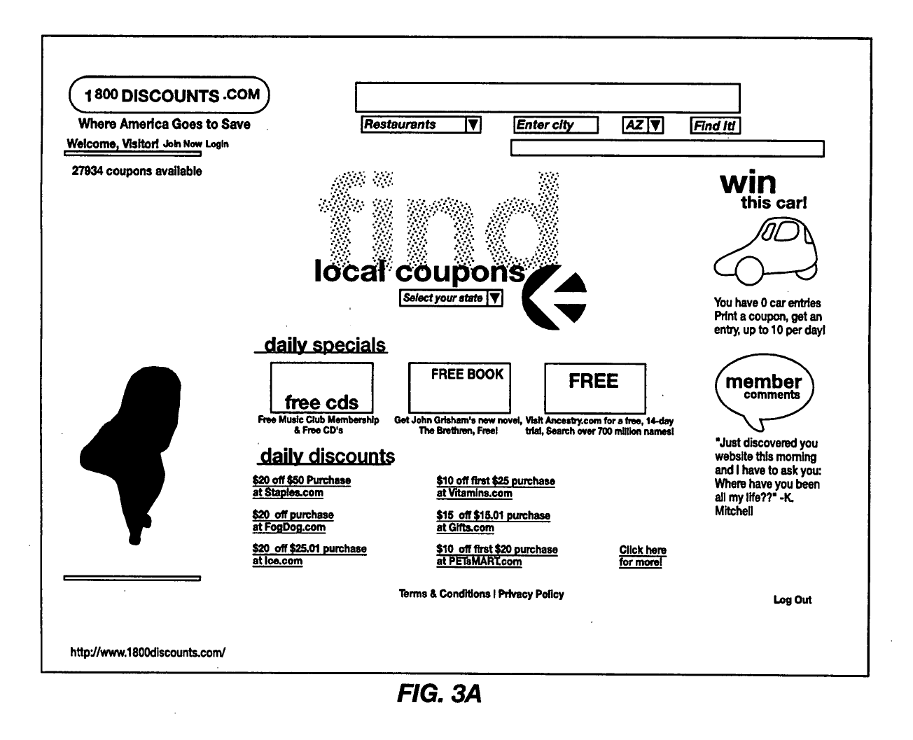

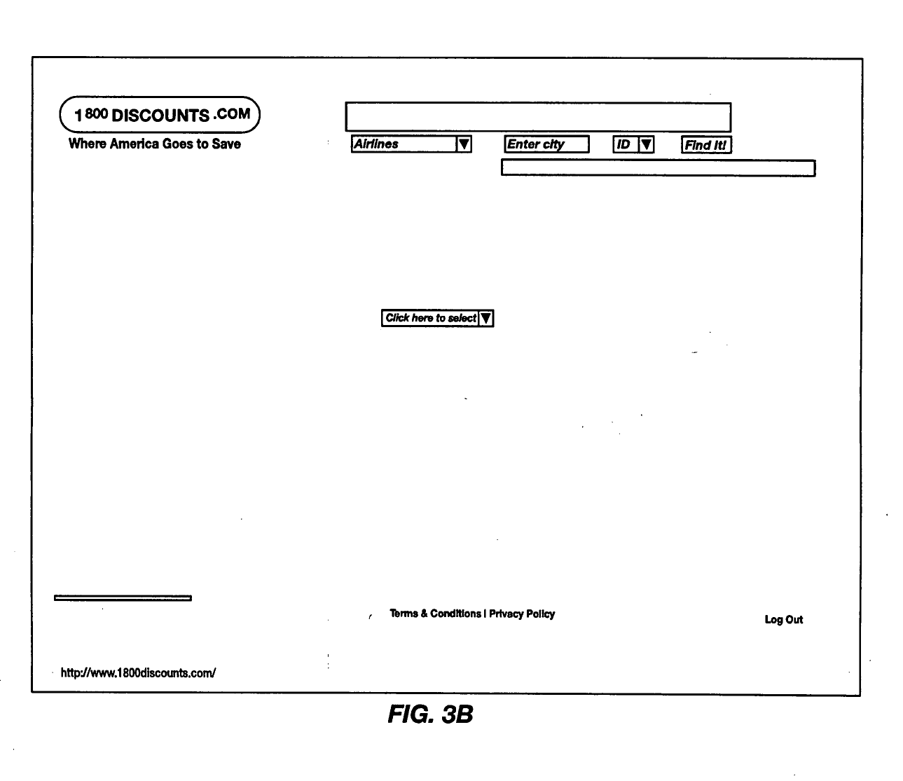

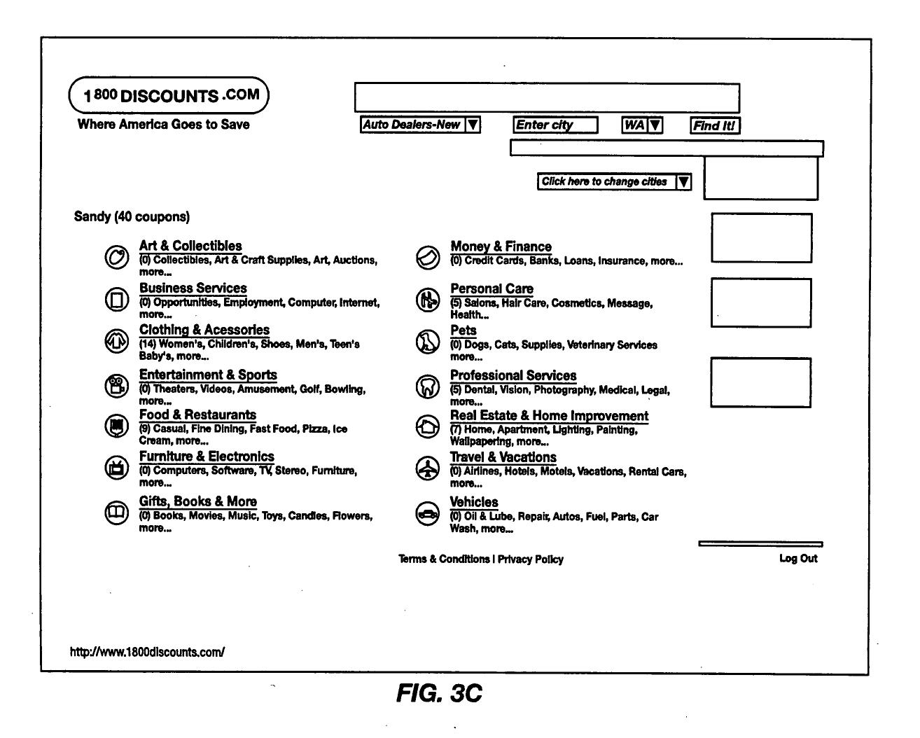

FIGS. 3A-C provide preferred graphical arrangements for presenting information to a computer user. It will be appreciated that FIGS. 3A-C are merely exemplary of some aspects of the present invention and not all the features of the present invention are represented therein and that other information, which will be described later herein, can also be preferably included in the material which is presented to the computer user. As those skilled in the art will appreciate, any of the computer programs known in the industry as world wide web browsers are used in connection with the present invention.

As shown in FIG. 3C, the promotional material may be organized in numerous different categories. For example, the categories may include: food, restaurants, clothing, gifts, books, travel, business services, art, collectibles, personal care, entertainment, sports, furniture, electronics, vehicles, real estate, home improvement, professional services, money, finance, pets, transportation, beauty, fitness, leisure, technology, or communications. As those skilled in the art will appreciate, other categories can be used within the scope of the present invention to organize the promotional material. The consumer is directed to select a category of promotional material from the list 30 (see FIG. 2). As a consumer selects a category, a list of subcategories is displayed 31. The consumer is directed to select from the list of subcategories 32 to further define the area of interest of promotional material.

Referring again generally to FIG. 2, once the subcategory is selected, the stage three begins, shown generally at 33. Stage three involves providing a list of promotional material 34 available in the selected geographical location and the selected category. The promotional material may be in the form of coupons, discounts, or cash back offers, for example. The consumer is directed to select the desired promotional material 35, whereupon coupons may be printed from a printer connected to the computer. The coupon may then be redeemed for a discount on goods or services at the applicable place of business. The discounts and cash back offers are available by purchasing goods or services through computer links to business websites from the displayed promotional material.

With an understanding of the forgoing techniques for guiding a computer user to promotional materials, a description of a further improvement provided by the present invention, referred to herein as the weekly advertisement portion of the present invention, will now be explained. Consumers are accustomed to browsing advertisements in a variety of printed forms such as in newspapers or magazines for example. Sunday editions of newspapers often have a supplement of advertisements from various businesses, principally retailers, including goods and services on sale in a particular geographic area. However, a consumer must obtain a copy of the newspaper to receive the weekly advertisements. Furthermore, the advertisements are not organized in a manner to allow easy access to the desired advertisements, and the advertisements are cumbersome to save and are often discarded before their usefulness is finished.

The present invention is very beneficial to consumers since advertisements are placed on a website for easy access. Furthermore, the advertisements appear in a form which is familiar to the consumers since the advertisements appear in a format which is well-known to consumers which are acquainted with the printed advertisements.

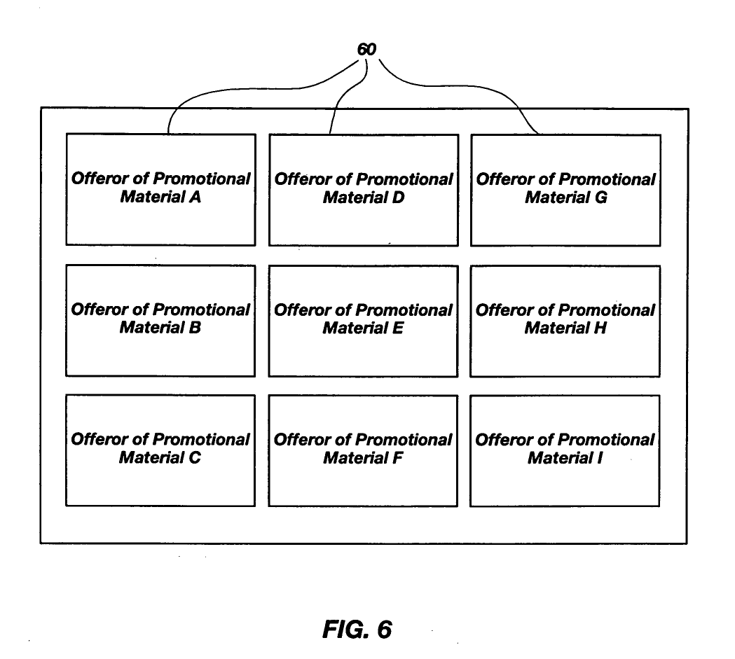

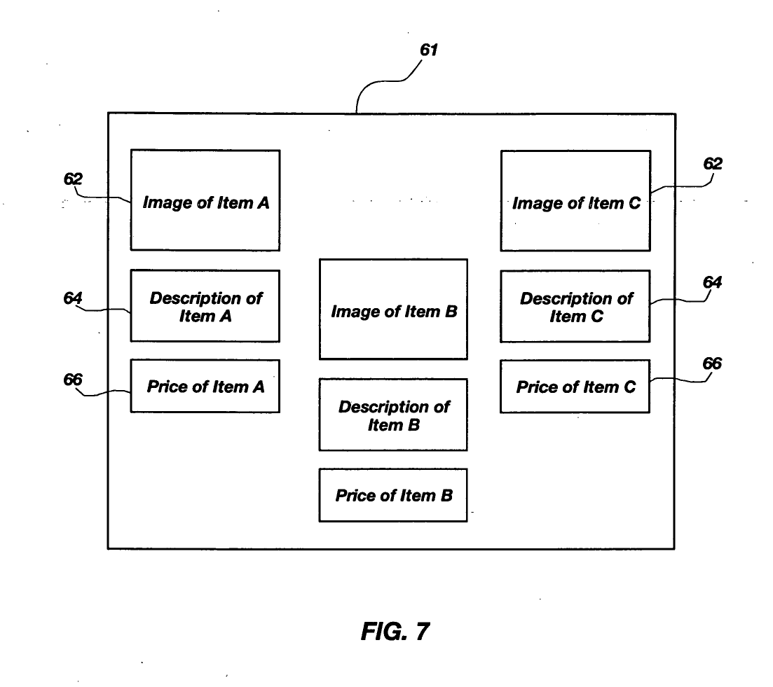

The website 12 (see FIG. 1) which is implementing the present invention displays a list of offerors 60 of the promotional material, as shown in FIG. 6. Offerors 60 include entities associated with the promotional material such as retailers, business establishments, restaurants, government agencies or any other entity desiring to provide promotional material. The consumer may browse the listed offerors 60 of promotional material and select a particular offeror by clicking on it with a mouse to display the associated promotional material as shown in FIG. 7. FIG. 7 is a diagrammatic representation of one preferred arrangement of a graphical interface presented to a computer user in accordance with the present invention, for example a page encoded in HTML conveyed via the world wide web on the internet as is well-known to those skilled in the art. The associated promotional material may have any desired appearance, but preferably has the same appearance as promotional material printed in weekly advertisements, such as those included in Sunday editions of newspapers.

Further information regarding the computer language HTML can be obtained from publication: Holzner, Steven, HTML Black Book (Coriolis Group 2000), which is now incorporated herein by reference in its entirety.

Referring now to FIG. 7, the promotional material presented to a computer user may include a page 61 having an image 62 of an item on sale, a description 64 of the item on sale, and the price 66 of the item, for example, all of which corresponds to the appearance of corresponding items in a printed weekly advertisement. This format for presenting promotional material to a computer user is already familiar to the computer user (from the computer user's association with printed advertisements) and allows the computer user to easily find advertisements the computer user may have seen elsewhere in a printed form. In accordance with the present invention, the described method and arrangement is also much more convenient for the consumer since the consumer need not purchase and save newspapers and magazines to access desired promotional material. Once the computer user arrives at the web page represented in FIG. 7, the computer user may browse by clicking through various pages of the promotional material and also click on a portion of a page to enlarge it for easier viewing and, if desired, printing.

Those skilled in the art will appreciate the great advance the techniques described herein provide over those which have been heretofore available. The methods and arrangements described herein can be utilized individually or combined to provide the greatest benefit, as will be appreciated by those skilled in the art having an understanding of the present invention.

As discussed earlier, many consumers utilize print advertisements, such as newspapers, to learn of products which are available for purchase from nearby retailers and to decide which products the consumer will purchase and where the consumer will purchase those products. In particular, in consumers utilize the Sunday edition of a local newspaper to determine which products will be purchased and from which local retailers those products will be purchased from. Many such advertisements are those which appear in a discrete “pull out” portion of the Sunday edition of the newspaper referred to as a “Sunday supplement.” Generally, each Sunday supplement contains advertisements for only one retailer. Thus, a Sunday edition of a newspaper may contain many Sunday supplements and the Sunday supplements may comprise a significant portion of the bulk of the entire Sunday edition of many newspapers.

While the sector of the economy referred to as “electronic ecommerce” or “ecomerce” is growing at an greatly increasing rate, many consumers are hesitant to “go online” to purchase products or even to merely obtain information about products to purchase from a traditional “bricks and mortar” local retailer. In accordance with one aspect of the present invention, the present invention advantageously provides a method of guiding computer users to, and through, an on line version of the Sunday supplement advertisement for one or more retailers. The computer user, even a consumer who is hesitant to go online to obtain information about products available for purchase, are presented with familiar and easy to use interfaces, as will next be explained.

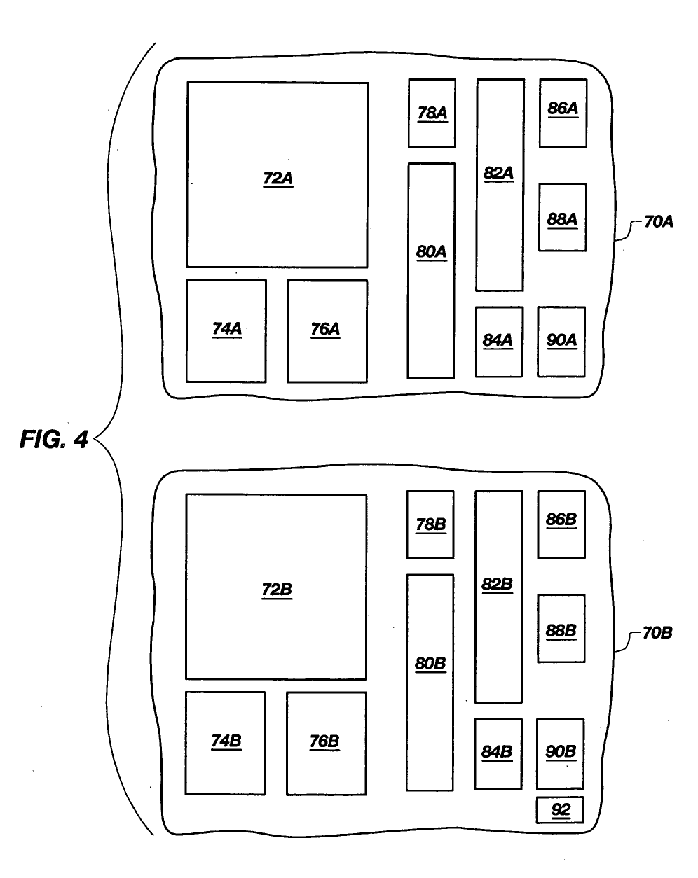

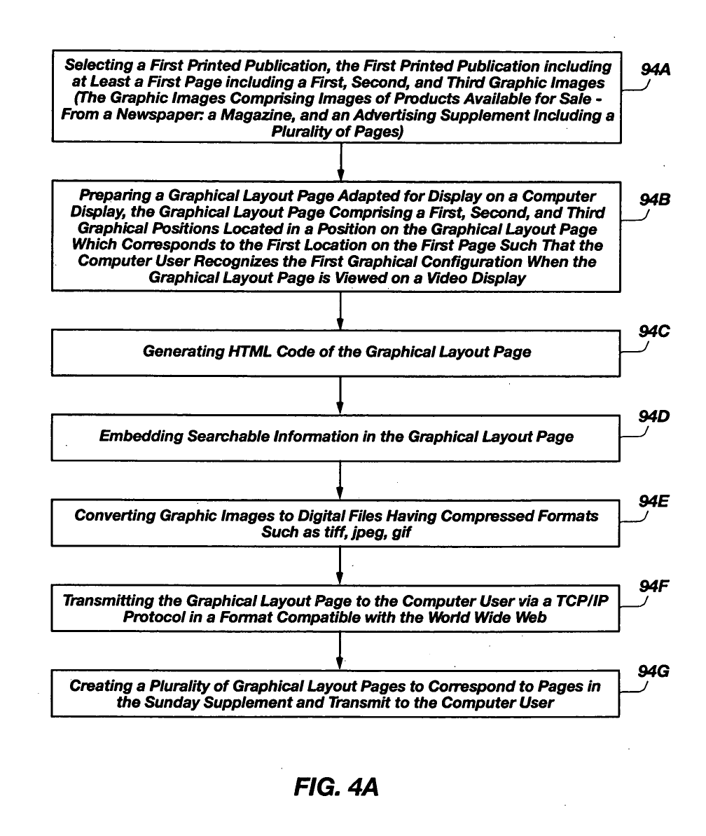

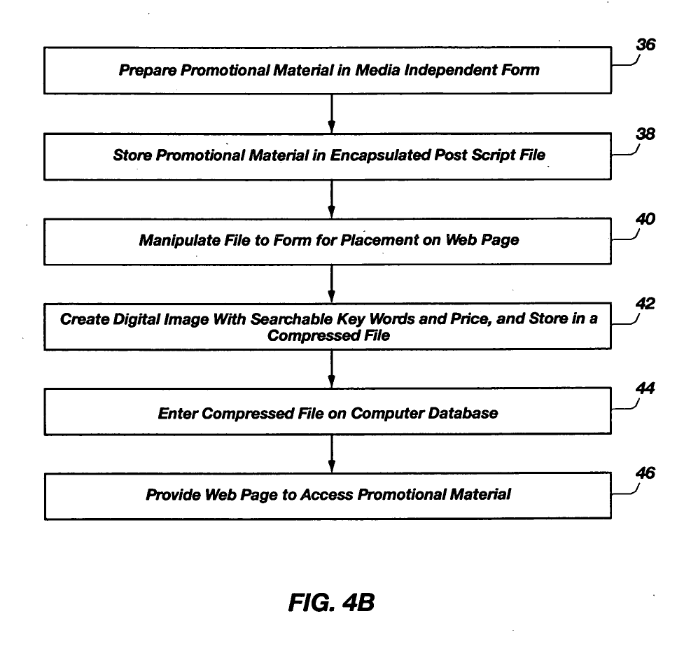

Reference will next be made to FIG. 4 which is a diagrammatic representation of a preferred relationship between the appearance of a printed publication 70A and the appearance of a computer display 70B of a computer user (not represented) configured in accordance with the present invention. The printed publication 70A can be any type of printed publication but it is preferred that the printed publication 70A is one page out of a advertising supplement which is distributed with a periodical publication, such as a Sunday edition newspaper. The printed publication has a graphical configuration which is created by the individual graphic images represented by the boxes (72A, 74A, 76A, 78A, 80A, 82A, 84A, 86A, 88A & 90A). In addition to the graphic images, the graphical configuration preferably includes textual material, which may occupy the same position on the printed publication as the graphic images (72A, 74A, 76A, 78A, 80A, 82A, 84A, 86A, 88A & 90A) or the textual material may be positioned on the printed publication independently of the graphic images. It will be appreciated that some printed publications may lack graphic images and may contain only textual material and the present invention also has application in such printed publications but it will be appreciated that the promotional materials which benefit the most from the present invention nearly always include graphic images of products which are available for purchase.

The present invention advantageously presents to a computer user a graphical layout page which is directly correlated with the appearance of the printed publication as shown in FIG. 4. In FIG. 4, a computer display 70B of some type is represented. The computer display can be any device which is capable of providing a visually perceptible representation of graphical or textual material, as is well known in the art.

In the preferred example represented in FIG. 4, each graphic image (72A, 74A, 76A, 78A, 80A, 82A, 84A, 86A, 88A & 90A) included in the printed publication 70A also has a corresponding graphic image (72B, 74B, 76B, 78B, 80B, 82B, 84B, 86B, 88B & 90B) generated on the computer display 70B. It is to be appreciated that it is presently preferred that the computer display 70B is presenting a website which has been generated and transmitted to the computer display 70B in accordance with the present invention.

Importantly, the arrangement of the graphic images (72B, 74B, 76B, 78B, 80B, 82B, 84B, 86B, 88B & 90B) generated on the computer display is familiar to the computer user, who is assumed to be familiar with either the exact printed publication 70A or familiar with other printed publications which are similar to the printed publication 70A. The relationship between the printed publication 70A and the computer display 70B makes the computer user comfortable and encourages the computer user to browse and examine the information provided on the computer display. It will be appreciated that due to differences in the computer displays, the appearance of the images on the computer display may not be identical to the appearance of the corresponding images in the printed publication, due to many different technical considerations, but the computer user will still perceive what is shown on the computer display as corresponding to what is included the printed publication.

The computer user is able to change the computer display, for example by clicking on a page button 92 to see another view another representation of another page of the printed publication 70A. It is preferred that an entire printed publication be reproduced in accordance with the present invention so that if a computer user remembers seeing a particular product advertised in a Sunday supplement from the previous weekend, the computer user will be able to view one page after another, in sequence, on the computer display. Also, the computer user can search for text and keywords in accordance with the present invention using techniques well-known in the art.

In FIG. 4 the each of the graphic images (72A, 74A, 76A, 78A, 80A, 82A, 84A, 86A, 88A & 90A) included in the printed publication 70A also has a corresponding graphic image (72B, 74B, 76B, 78B, 80B, 82B, 84B, 86B, 88B & 90B) generated on the computer display positioned in a location very similar to the position of the images provided in the printed publication 70A. It will be appreciated that it is within the scope of the present invention to provide only some corresponding graphic images (for example, 72B, 74B, 76B) on the computer display 70B and to provide them in an arrangement which is not strictly the same as that provided in the printed publication 70A). The relationship between the appearance of the computer display 70B and the printed publication 70A should be sufficiently correlated to allow the computer display 70B to be familiar to the computer user.

Reference will now be made to FIG. 4A to further describe the preferred techniques used to generate and convey to the computer user the computer display 70B represented in FIG. 4. The preferred method of presenting promotional material to a computer user described herein is just one possible arrangement for carrying out the present invention.

Referring now to FIG. 4A, as represented at step 94A, a printed publication is selected. The printed publication preferably includes an exemplary first page which will be used to describe the steps represented in FIG. 4A, but most printed publication will have multiple pages which are subjected to the method of the present invention. Still, a single page can be selected from a printed publication, from somewhere in the printed publication without regard to the order of pages within the printed publication, and still receive the benefits of the present invention. The printed publication may be any number of different types of printed publications, including a newspaper; a magazine, and an advertising supplement, each of which preferably include a plurality of pages. While not intended to be limiting of the scope of the present intention, the present invention does have the greatest benefit when the graphic images include images of products available for purchase. The selected page from the printed publication preferably has a graphical configuration including at least: a first graphic image positioned in a first location on the first page, a second graphic image positioned in a second location on the first page; and, a third graphic image positioned in a third location on the first page.

A graphical layout page is prepared as indicated at step 94B. The graphical page layout is adapted for display on a computer display (see 70B in FIG. 4). The graphical layout page includes: a first graphical position located in a position on the graphical layout page which corresponds to the first location on the first page; a second graphical position located in a position on the graphical layout page which corresponds to the second location on the first page; and, a third graphical position located in a position on the graphical layout page which corresponds to the third location on the first page. Thus, the graphical layout page appears familiar and closely similar to the appearance of the printed publication (70A in FIG. 4). In particular, the first, second, and third graphical positions are located in their respective positions on the graphical layout page to create a second graphical configuration. The visual impression conveyed by the second graphical configuration to the computer user is recognized as the first graphical configuration (of the printed publication) by the computer user when the graphical layout page is viewed on a computer display (70B in FIG. 4).

It is preferred that the graphical layout page be encoded in computer code which will cause the computer display (70B in FIG. 4) to provide the correct layout to the computer user, such as those computer languages well-know in the art as HTML (see step 94C in FIG. 4A), XML, and any other language or technique which is now know, or which becomes known in the future, to convey graphical and textual material via a computer network. The graphic images are preferably fixed in digital files having a format compatible with the well-known tiff, jpeg, and gif formats (step 94E in FIG. 4A). It is also preferred to provide the computer user with key words and numeric information which can be searched to find corresponding graphic images on the computer display. The key words and numeric information are preferably embedded in the graphical layout page (step 94D in FIG. 4A).

It is preferred that when a computer user clicks (or takes other appropriate affirmative action) on the graphical images on the computer display, the computer user is directed to an enlarged graphical image which appears on the computer display.

Included in the method of the present invention is transmitting the graphical layout page to the computer display using whatever protocol, either now available or available in the future, to the computer display (70B in FIG. 4), for example utilizing the TCP/IP protocol which is currently the standard on the internet (step 94F in FIG. 4A). As the computer user desires to view additional images corresponding to pages of the printed publication (70A in FIG. 4) additional pages are transmitted to the computer user via the internet (step 94G in FIG. 4A).

Preparing the promotional material for placement on the website 12 is readily accomplished by those skilled in the art with an understanding of the principles discussed herein, as will now be explained. As shown in FIG. 4B, a business or offeror who desires to provide promotional material in the form of advertisements prepares the promotional material in a media independent form 36 such as a file compatible with the QUARK XPRESS™ format which is well known to those skilled in the graphic arts industry. A media independent publication is a master version of the content which can be quickly and efficiently delivered through different media such as print, on the Web, and through wireless devices.

Next, the promotional material is preferably stored in an encapsulated postscript file 38, commonly referred to as an eps file. An encapsulated postscript file is generally used for graphics files that are to be incorporated into other documents and includes information such as the bounding box, page number and fonts used. An image manipulation program such as PHOTOSHOP™ is then preferably used to manipulate the encapsulated postscript file to a form for placement on a web page 40. Then a digital image of the manipulated encapsulated postscript file is preferably compressed and stored in a file 42 commonly referred to as a jpg file (Joint Photographers Expert Group). The jpg file includes a digital image for inclusion on a web page, for example providing graphic images to be seen in the advertisements. Also included in an appropriate format, for example HTML, keywords and prices for each item advertised are also included. The keywords are preferably any suitable descriptive words corresponding to the item which would enable a computer user to find the item by performing a search for the keyword using search tools or search engines. The jpg file is next preferably entered on a computer database 44 so that the promotional material can be accessed through a web page 46 connected to a computer network.

Further information regarding the use of the QUARK XPRESS™ and PHOTOSHOP™M programs can be found in the publications: Bouton, Gary David, Bouton, Barbara & Kubicek, Gary, Inside Adobe Photoshop 5.5 (New Riders Publishing 2000) and Assadi, Barbara, Gruman, Galen & Cruise, John, Quark Xpress 4 for Dummies (IDG Books 1998), which are now incorporated herein by reference in their entireties.

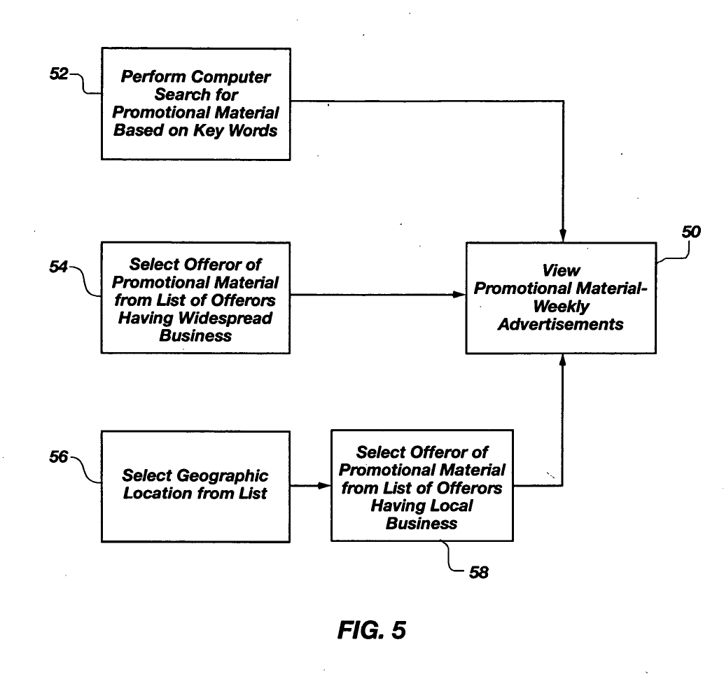

Using the techniques and structures described herein, a computer user is directed to the promotional material in the form of weekly advertisements 50 from a particular business or offeror in various ways as shown in FIG. 5. One procedure a computer user is directed to desired promotional material is by performing a search 52 on key words applicable to the promotional material of interest. Also, businesses or offerors 60 of promotional material, such as franchises or national chain stores with wide geographic coverage, are listed on the web page. As indicated in FIG. 5, a computer user can select such businesses listed to display a listing of promotional material available 54. Also as represented in FIG. 5, computer users can also select a geographic location 56, in a similar manner as described in stage 1 described above, to retrieve a list of local business establishments with promotional material available. A local business can then preferably be selected from the list to view the promotional material for the local business 58.

While the above-provided description provides one skilled in the art with all the guidance necessary to make and us the present invention, attached hereto, and incorporated herein by reference, is a Programming Code Appendix, which will provide one skilled in the pertinent art further preferred examples of the structures and techniques used to carry out the present invention. The programming code provided in the attached Programming Code Appendix is exemplary of the code used to implement portions of the methods and structures described in connection with FIGS. 1-7.

In view of the foregoing, it will be appreciated that the present invention provides a system and method for guiding a computer user to promotional material which is readily followed and which groups the promotional material into easily distinguished categories. The present invention also provides the user with a familiar easily used computer database interface which corresponds to the visual appearance of advertisements when they appear in commonly distributed printed form. Thus, the present invention also provides a system and method for guiding a computer user to the promotional material which is applicable to a selected geographic area, and in which the promotional material includes weekly advertisements. The present invention also provides a system and method for guiding a computer user to the promotional material which provides for efficient distribution of promotional material.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made without departing from the principles and concepts set forth herein.

1. A method of presenting promotional material to a computer user, the method comprising the steps of:
selecting a first printed publication, the first printed publication including a first page located somewhere in the first printed publication without regard to the order of pages within the printed publication, the first page having a first graphical configuration, the first graphical configuration comprising:
a first graphic image positioned in a first location on the first page,
a second graphic image positioned in a second location on the first page; and
a third graphic image positioned in a third location on the first page;
preparing a graphical layout page adapted for display on a computer display, the graphical layout page comprising:
a first graphical position located in a position on the graphical layout page which corresponds to the first location on the first page;
a second graphical position located in a position on the graphical layout page which corresponds to the second location on the first page; and
a third graphical position located in a position on the graphical layout page which corresponds to the third location on the first page;
the first, second, and third graphical positions being located in their respective positions on the graphical layout page to create a second graphical configuration, the visual impression conveyed by the second graphical configuration to the computer user, when the first, second, and third graphical images are placed in the first graphical position, the second graphical position, and the third graphical position, respectively, is recognized as the first graphical configuration by the computer user when the graphical layout page is viewed on a video display.

2. A method of presenting promotional material to a computer user as defined in claim 1 wherein the step of selecting a first printed publication comprises the step of selecting a printed publication from the group consisting of: a newspaper; a magazine, and an advertising supplement.

3. A method of presenting promotional material to a computer user as defined in claim 1 wherein the first printed publication comprises a plurality of pages.

4. A method of presenting promotional material to a computer user as defined in claim 1 wherein when the computer user clicks on the first graphical position the computer user is directed to an enlarged graphical image.

5. A method of presenting promotional material to a computer user as defined in claim 1 wherein the first graphic image comprises an image of a product available for sale.

6. A method of presenting promotional material to a computer user as defined in claim 1 wherein the first graphical layout page further comprises HTML code.

7. A method of presenting promotional material to a computer user as defined in claim 1 wherein searchable information is embedded in the graphical layout page.

8. A method of presenting promotional material to a computer user as defined in claim 1 wherein the first, second, and third graphic images are fixed in a digital file having a format selected from the group consisting of: tiff, jpeg, gif, and bmp.

9. A method of presenting promotional material to a computer user as defined in claim 1 further comprising the step of transmitting the graphical layout page to the computer user via a TCP/IP protocol.

10. A method of presenting promotional material to a computer user as defined in claim 1 wherein the graphical layout page is stored in a format compatible with the world wide web.

11. A method of presenting promotional material to a computer user as defined in claim 1 wherein the graphical layout page comprises a plurality of graphical layout pages.

12. A method of presenting promotional material to a computer user as defined in claim 1 wherein the first printed publication is stored in a format compatible with QUARK XPRESS and wherein the graphical layout page is in a format compatible with a markup language selected from the group consisting of XML and HTML and the method further comprises the step of converting the format compatible with QUARK XPRESS to a format compatible with a markup language.

13. A method of presenting promotional material to a computer user as defined in claim 1 wherein:
the first location is the upper left portion of the first page and the first graphical position is the upper left of the graphical layout page;
the second location is the upper right portion of the first page and the first graphical position is the upper left of the graphical layout page; and
the first location is the lower right portion of the first page and the first graphical position is the lower right of the graphical layout page.

14. A method of presenting promotional material to a computer user as defined in claim 1:
wherein the step of preparing a graphical layout page further comprises the step of embedding textual material and wherein the method further comprising the step of the computer user searching for the textual material.

15. A method of presenting promotional material to a computer user as defined in claim 1 further comprising the steps of:
providing the computer user with a list of geographic locations where the promotional material is available;
directing the computer user to select a desired location from the list of geographic locations where the promotional material is available; and
providing the promotional materials available for the selected geographic location.

16. A method of presenting promotional material to computer user, the method comprising:
selecting a first printed publication, the first printed publication including a first page located somewhere in the first printed publication without regard to the order of pages within the printed publication, the first page having a first graphical configuration, the first graphical configuration comprising:
a first graphic image positioned in a first location on the first page,
a second graphic image positioned in a second location on the first page; and
a third graphic image positioned in a third location on the first page;
preparing a graphical layout page adapted for display on a computer display, the graphical layout page comprising:
the first graphic image positioned on the graphical layout page;
the second graphic image positioned on the graphical layout page; and
the first graphic image positioned on the graphical layout page;
the first, second, and third graphic images being positioned on the graphical layout page such that all of the graphical information presented on the first page is also presented on the graphical layout page to the computer user when the graphical layout page is viewed on a video display.

17. A method of presenting promotional material to a computer user as defined in claim 16 wherein the step of selecting a first printed publication comprises the step of selecting a printed publication from the group consisting of: a newspaper; a magazine, and an advertising supplement.

18. A method of presenting promotional material to a computer user as defined in claim 16 wherein the first printed publication comprises a plurality of pages.

19. A method of presenting promotional material to a computer user as defined in claim 16 wherein the first graphic image comprises an image of a product available for sale.

20. A method of presenting promotional material to a computer user as defined in claim 16 wherein the first graphical layout page further comprises HTML code.

21. A method of presenting promotional material to a computer user as defined in claim 16 wherein searchable information is embedded in the graphical layout page.

22. A method of presenting promotional material to a computer user as defined in claim 16 wherein the first, second, and third graphic images are fixed in a digital file having a format selected from the group consisting of: tiff, jpeg, gif, and bmp.

23. A method of presenting promotional material to a computer user as defined in claim 16 further comprising the step of transmitting the graphical layout page to the computer user via a TCP/IP protocol.

24. A method of presenting promotional material to a computer user as defined in claim 16 wherein the graphical layout page is stored in a format compatible with the world wide web.

25. A method of presenting promotional material to a computer user as defined in claim 16 wherein the graphical layout page comprises a plurality of graphical layout pages.

26. A method of presenting promotional material to a computer user as defined in claim 16 wherein the first printed publication is stored in a format compatible with QUARK XPRESS and wherein the graphical layout page is in a format compatible with a markup language selected from the group consisting of XML and HTML and the method further comprises the step of converting the format compatible with QUARK XPRESS to a format compatible with a markup language.

27. A method of presenting promotional material to a computer user as defined in claim 16:
wherein the step of preparing a graphical layout page further comprises the step of embedding textual material and wherein the method further comprising the step of the computer user searching for the textual material.

28. A method of presenting promotional material to a computer user as defined in claim 16 further comprising the steps of:
providing the computer user with a list of geographic locations where the promotional material is available;
directing the computer user to select a desired location from the list of geographic locations where the promotional material is available; and
providing the promotional materials available for the selected geographic location.

29. A method of presenting advertising material which appears in a printed publication to a computer user, the advertising material comprising at least one page of graphical and textual material, the method comprising the steps of:
converting the at least one page of graphical and textual material into a first computer file arranged in a format which can be conveyed to the computer user via a global computer network;
transmitting the first computer file to the computer user via the global computer network;
displaying the graphical and textual material in a visually perceptible manner to the computer user such that the computer user perceives the graphical and textual material on a display in substantially the same arrangement which they appear on the at least one page in the printed publication.

30. A method of presenting advertising material which appears in a printed publication to a computer user as defined in claim 29 wherein the first printed publication is selected from the group consisting of: a newspaper; a magazine, and an advertising supplement.

31. A method of presenting advertising material which appears in a printed publication to a computer user as defined in claim 29 wherein the printed publication comprises a plurality of pages.

32. A method of presenting advertising material which appears in a printed publication to a computer user as defined in claim 29 wherein the graphical material comprises an image of a product available for sale.

33. A method of presenting advertising material which appears in a printed publication to a computer user as defined in claim 29 wherein the step of converting the at least one page comprises the step of generating HTML code.

34. A method of presenting advertising material which appears in a printed publication to a computer user as defined in claim 29 wherein the textual material is searchable by the computer user.

35. A method of presenting advertising material which appears in a printed publication to a computer user as defined in claim 29 wherein the step of converting the at least one page comprises the step of converting the at least one page comprises the step of converting the graphical material into at least one digital file having a format selected from the group consisting of: tiff, jpeg, gif, and bmp.

36. A method of presenting advertising material which appears in a printed publication to a computer user as defined in claim 29 wherein the step of transmitting the first computer file comprises the step of transmitting the first computer file to the computer user via a TCP/IP protocol.

37. A method of presenting promotional material to a computer user as defined in claim 29 wherein the graphical layout page is stored in a format compatible with the world wide web.

38. A method of presenting promotional material to a computer user as defined in claim 29 wherein the graphical layout page comprises a plurality of graphical layout pages.

39. A method of presenting promotional material to a computer user as defined in claim 29 wherein the first printed publication is stored in a format compatible with QUARK XPRESS and wherein the graphical layout page is in a format compatible with a markup language selected from the group consisting of XML and HTML and the method further comprises the step of converting the format compatible with QUARK XPRESS to a format compatible with a markup language.

40. A method of presenting promotional material to a computer user as defined in claim 29 wherein:
the first location is the upper left portion of the first page and the first graphical position is the upper left of the graphical layout page;
the second location is the upper right portion of the first page and the first graphical position is the upper left of the graphical layout page; and
the first location is the lower right portion of the first page and the first graphical position is the lower right of the graphical layout page.

41. A method of presenting promotional material to a computer user as defined in claim 29:
wherein the step of preparing a graphical layout page further comprises the step of embedding textual material and wherein the method further comprising the step of the computer user searching for the textual material.

42. A method for providing promotional material to a computer user, said promotional material being stored electronically on a computer database, said method comprising the steps of:
(A) preparing the promotional material in a media independent form;
(B) storing the promotional material in an encapsulated postscript file;
(C) manipulating the encapsulated postscript file to a form for placement on a web page;
(D) creating a digital image of the manipulated encapsulated postscript file and storing the digital image in a compressed file;
(E) entering the compressed file on the computer database;
(F) providing the web page for the computer user to access the promotional material.

43. The method for providing promotional material as provided in claim 42 wherein step (D) creating a digital image of the manipulated encapsulated postscript file and storing the digital image in a compressed file further comprises the step of storing key words in the compressed file.

44. The method for providing promotional material as provided in claim 43 wherein the keywords comprise a price for an item in the promotional material.

45. The method for providing promotional material as provided in claim 43 further comprising the step of providing a search engine for the computer user to search for the promotional material based on the key words.

46. The method for providing promotional material as provided in claim 42 further comprising the step of providing the computer user with a list of geographic locations where the promotional material is available.

47. The method for providing promotional material as provided in claim 46 further comprising the step of directing the computer user to select a desired location from the list of geographic locations where the promotional material is available.

48. The method for providing promotional material as provided in claim 47 wherein a list of offerors of the promotional material is provided for the selected geographical location.

49. The method for providing promotional material as provided in claim 48 wherein the computer user accesses the promotional material by selecting the desired offeror of the promotional material.

50. A method for guiding a computer user to promotional materials stored electronically on a computer database, said method comprising the steps of:
(A) providing the computer user with a list of geographic locations where the promotional material is available;
(B) directing the computer user to select a desired location from the list of geographic locations where the promotional material is available;
(C) providing the computer user with a list of offerors of promotional material in the selected geographic location;
(D) directing the computer user to select a desired offeror of promotional material; and
(E) displaying the promotional materials available on the computer database for the selected offerors of promotional material.

51. The method for guiding a computer user to promotional material as provided in claim 50 wherein the promotional material comprises periodic advertisements published by the offerors.

52. The method for guiding a computer user to promotional material as provided in claim 50 wherein the published advertisement is stored in a media-independent form.

53. The method for guiding a computer user to promotional material as provided in claim 52 wherein the media-independent form is stored in an encapsulated postscript file.

54. The method for guiding a computer user to promotional material as provided in claim 53 wherein the encapsulated postscript file is manipulated to a suitable form for a web page.

55. The method for guiding a computer user to promotional material as provided in claim 54 wherein a digital image of the manipulated encapsulated postscript file is stored in a compressed file.

56. The method for guiding a computer user to promotional material as provided in claim 55 wherein the compressed file is entered on the computer database.

57. The method for guiding a computer user to promotional material as provided in claim 56 wherein the computer user accesses the promotional material through the web page.

58. The method for guiding a computer user to promotional material as provided in claim 55 wherein the compressed file comprises key words.

59. The method for guiding a computer user to promotional material as provided in claim 58 wherein the key words comprise a price for an item in the promotional material.

60. The method for guiding a computer user to promotional material as provided in claim 58 wherein the computer user locates the promotional material by performing a search on the key words.

61. A method for guiding a computer user to promotional materials stored electronically on a computer database, said method comprising the steps of:
(A) providing the computer user with a list of geographic locations where the promotional material is available;
(B) directing the computer user to select a desired location from the list of geographic locations where the promotional material is available; and
(C) providing the promotional materials available for the selected geographic location.

62. The method for guiding a computer user to promotional materials stored electronically on a computer database as provided in claim 61 further comprising the step of providing the computer user with a list of categories of the promotional material.

63. The method for guiding a computer user to promotional materials stored electronically on a computer database as provided in claim 62, further comprising the step of directing the computer user to select from the list of categories of the promotional material.

64. The method for guiding a computer user to promotional materials stored electronically on a computer database as provided in claim 63, further comprising the step of providing a list of subcategories of the promotional material.

65. The method for guiding a computer user to promotional materials stored electronically on a computer database as provided in claim 64, further comprising the step of directing the computer user to select from the list of subcategories.

66. The method for guiding a computer user to promotional materials stored electronically on a computer database as provided in claim 62, wherein the list of categories includes at least one of the group consisting of: food and restaurants; clothing and accessories; gifts, books and more; travel; business services; art and collectibles; personal care; entertainment and sports; furniture and electronics; vehicles; real estate and home improvement; professional services; money and finance; and pets.

67. The method for guiding a computer user to promotional materials stored electronically on a computer database as provided in claim 15, 28, 617 wherein step (A) comprises providing the computer user with a list of broad geographic locations where the promotional material is available, and directing the computer user to select from the list of broad geographic locations.

68. The method for guiding a computer user to promotional materials stored electronically on a computer database as provided in claim 67, wherein the list of broad geographic locations comprises states.

69. The method for guiding a computer user to promotional materials stored electronically on a computer database as provided in claim 67, further comprising the step of providing the computer user with a list of specific geographic locations where the promotional material is available, and directing the computer user to select from the list of specific geographic locations.

70. The method for guiding a computer user to promotional materials stored electronically on a computer database as provided in claim 69, wherein the list of specific geographic locations comprises cities.

71. The method for guiding a computer user to promotional materials stored electronically on a computer database as provided in claim 15, 28, 61, wherein the promotional material comprises coupons.

72. The method for guiding a computer user to promotional materials stored electronically on a computer database as provided in claim 15, 28, 61, wherein the promotional material comprises discounts available by purchasing goods or services through a website linked to the promotional material.

73. The method for guiding a computer user to promotional materials stored electronically on a computer database as provided in claim 15, 28, 61, wherein the promotional material comprises cash back offers available by purchasing goods or services through a website linked to the promotional material.

74. The method for guiding a computer user to promotional materials stored electronically on a computer database as provided in claim 71 wherein the coupons are printed from a printer connected to the computer.

75. The method for guiding a computer user to promotional materials stored electronically on a computer database as provided in claim 61 wherein the computer user accesses the promotional material through a website.

76. The method for guiding a computer user to promotional materials stored electronically on a computer database as provided in claim 75, wherein the computer user accesses the promotional material through a banner ad link on a host website.

77. The method for guiding a computer user to promotional materials stored electronically on a computer database as provided in claim 61 further comprising the step of advertising the computer database containing the promotional material by one of the group consisting of referrals, television, radio, magazines, and newspapers.

78. A method for guiding a computer user to promotional materials stored electronically on a computer database, said method comprising the steps of:
(A) providing the computer user with a list of geographic locations where the promotional material is available;
(B) directing the computer user to select a desired location from the list of geographic locations where the promotional material is available;
(C) providing the computer user with a list of categories of the promotional material;
(D) directing the computer user to select a desired category from the list of categories of the promotional material; and
(E) providing the promotional materials available on the computer database for the selected geographic location and the selected category.

79. The method for guiding a computer user to promotional materials stored electronically on a computer database as provided in claim 78, wherein the list of geographic locations comprises a list of states.

80. The method for guiding a computer user to promotional materials stored electronically on a computer database as provided in claim 79, further comprising the step of directing the computer user to select from a list of cities.

81. The method for guiding a computer user to promotional materials stored electronically on a computer database as provided in claim 78, further comprising the step of directing the computer user to select from a list of subcategories.

82. The method for guiding a computer user to promotional materials stored electronically on a computer database as provided in claim 78, wherein the list of categories includes at least one of the group consisting of: food and restaurants; clothing and accessories; gifts, books and more; travel; business services; art and collectibles; personal care; entertainment and sports; furniture and electronics; vehicles; real estate and home improvement; professional services; money and finance; and pets.

83. The method for guiding a computer user to promotional materials stored electronically on a computer database as provided in claim 78, wherein the promotional material comprises coupons.

84. The method for guiding a computer user to promotional materials stored electronically on a computer database as provided in claim 78, wherein the promotional material comprises discounts available by purchasing goods or services through a website linked to the promotional material.

85. The method as provided in claim 78, wherein the promotional material comprises cash back offers available by purchasing goods or services through a website linked to the promotional material.

86. The method for guiding a computer user to promotional materials stored electronically on a computer database as provided in claim 83, wherein the coupons are printed from a printer connected to the computer.

87. The method for guiding a computer user to promotional materials stored electronically on a computer database as provided in claim 78, wherein the computer user accesses the promotional material through a website.

88. The method for guiding a computer user to promotional materials stored electronically on a computer database as provided in claim 87, wherein the computer user accesses the promotional material through a banner ad link on a host website.

89. The method for guiding a computer user to promotional materials stored electronically on a computer database as provided in claim 78, further comprising the step of advertising the computer database containing the promotional material by one of the group consisting of referrals, television, radio, magazines, and newspapers.

90. A system for guiding a computer user to promotional materials stored electronically on a computer database, said system comprising:
(A) means for providing the computer user with a list of geographic locations where the promotional material is available;
(B) means for directing the computer user to select a desired location from the list of geographic locations where the promotional material is available; and
(C) means for providing the promotional materials available for the selected geographic location to the computer user.

91. The system for guiding a computer user to promotional materials stored electronically on a computer database as provided in claim 90, further comprising means for directing the computer user to select from a list of categories of the promotional material.

92. The system for guiding a computer user to promotional materials stored electronically on a computer database as provided in claim 91, further comprising means for directing the computer user to select from a list of subcategories.

93. The system for guiding a computer user to promotional materials stored electronically on a computer database as provided in claim 91, wherein the list of categories includes at least one of the group consisting of: food and restaurants; clothing and accessories; gifts, books and more; travel; business services; art and collectibles; personal care; entertainment and sports; furniture and electronics; vehicles; real estate and home improvement; professional services; money and finance; and pets.

94. The system for guiding a computer user to promotional materials stored electronically on a computer database as provided in claim 90, wherein the list of geographic locations where the promotional material is available comprises a list of states.

95. The system for guiding a computer user to promotional materials stored electronically on a computer database as provided in claim 94, further comprising means for directing the computer user to select from a list of cities from a selected state where the promotional material is desired.

96. The system for guiding a computer user to promotional materials stored electronically on a computer database as provided in claim 90, wherein the promotional material comprises coupons.

97. The system for guiding a computer user to promotional materials stored electronically on a computer database as provided in claim 90, wherein the promotional material comprises discounts available by purchasing goods or services through a website linked to the promotional material.

98. The system for guiding a computer user to promotional materials stored electronically on a computer database as provided in claim 90, wherein the promotional material comprises cash back offers available by purchasing goods or services through a website linked to the promotional material.

99. The system for guiding a computer user to promotional materials stored electronically on a computer database as provided in claim 96, wherein the coupons are printed from a printer connected to the computer.

100. The system for guiding a computer user to promotional materials stored electronically on a computer database as provided in claim 90, wherein the computer user accesses the promotional material through a website.

101. The system for guiding a computer user to promotional materials stored electronically on a computer database as provided in claim 100, wherein the computer user accesses the promotional material through a banner ad link on a host website.

102. The system for guiding a computer user to promotional materials stored electronically on a computer database as provided in claim 90, wherein the computer database containing the promotional material is advertised by one of the group consisting of referrals, television, radio, magazines, and newspapers.
